(19) United States
(12) Patent Application Publication
(10) Pub. No.: US 2020/0111172 A1
(43) Pub. Date: Apr. 9, 2020

(54) METHOD, APPARATUS, AND COMPUTER-READABLE MEDIUM FOR EXPERTISE

(71) Applicant: DotAlign, Inc., New York, NY (US)

(72) Inventor: Vince Scafaria, Colts Neck, NJ (US)

(21) Appl. No.: 16/413,297

(22) Filed: May 15, 2019

Related U.S. Application Data
(60) Provisional application No. 62/790,656, filed on Jan. 10, 2019.
(60) Provisional application No. 62/671,720, filed on May 15, 2018.

(51) Int. Cl. G06Q 50/00; G06F 16/2458

(52) U.S. Cl. CPC G06Q 50/01; G06F 2216/03; G06F 16/2465

(57) ABSTRACT

Embodiments of the present disclosure provide a method, apparatus and computer-readable medium for determining expertise. An exemplary method includes analyzing, by a processor, a plurality of data of a user, wherein the data comprises at least words and phrases from at least one of emails, messages, and electronic communications, and receiving, by the processor, a second data, the second data comprising anonymous frequency word counts of a plurality of users. The method further includes determining, by the processor, a correspondence between the analyzed plurality of data and the second data, wherein the correspondence includes words and phrases that are interesting, and providing, by the processor, a list of words and phrases to the user based on the determined correspondence, wherein the list is selectable by the user.

### BACKGROUND OF THE INVENTION

### Field of the Invention

Exemplary embodiments of the present disclosure relate to a method, apparatus and computer-readable medium for determining expertise. Exemplary embodiments of the present disclosure relate more particularly to a method, apparatus, and computer-readable medium for determining expertise with privacy considerations.

### Description of Related Art

A social network is a social structure made up of a group of entities. Examples of entities include people, companies, and/or organizations. Analyzing a social network or a group of social networks can provide insights into the connections between the individuals contained with a particular social network, the ways in which social networks are formed, and how different networks may or may not be linked with one another.

Large organizations and companies can be part of a social network. Large organizations and companies can be part of a social network or in some instances they can contain a social network. In some instances a social network of a company can include its many customers, client contacts, and employees. Each of these individuals will have a number skills or expertise that may or may not be known by other individuals within the company or organization. Accordingly, there is a need to better understand the knowledge base of an individual's connections or collaborators.

### BRIEF SUMMARY OF THE INVENTION

In view of the foregoing, it is an object of the present disclosure to provide a method, apparatus, and computer-readable medium for determining.

A first exemplary embodiment of the present disclosure provides a method. The method includes analyzing, by a processor, a plurality of data of a user, wherein the data comprises at least words and phrases from at least one of emails, messages, documents, and electronic communications, and receiving, by the processor, a second data, the second data comprising anonymous frequency word counts of a plurality of users. The method further includes determining, by the processor, a correspondence between the analyzed plurality of data and the second data, wherein the correspondence includes words and phrases that are interesting, and providing, by the processor, a list of words and phrases to the user based on the determined correspondence, wherein the list is selectable by the user.

A second exemplary embodiment of the present disclosure provides an apparatus. An apparatus includes at least one processor and at least one memory storing computer program instructions executable by the at least one processor, wherein the at least one memory with the computer program instructions and the at least one processor are configured to cause the apparatus to at least analyze a plurality of data of a user, wherein the data comprises at least words and phrases from at least one of emails, messages, documents, and electronic communications, and receive a second data, the second data comprising anonymous frequency word counts of a plurality of users. The at least one memory with the computer program instructions and the at least one processor are further configured to cause the apparatus to determine a correspondence between the analyzed plurality of data and the second data, wherein the correspondence includes words and phrases that are interesting, and provide a list of words and phrases to the user based on the determined correspondence, wherein the list is selectable by the user.

A third exemplary embodiment of the present disclosure provides a computer-readable medium. The non-transitory computer-readable medium tangibly storing computer program instructions which when executed by a processor, cause the processor to at least analyze a plurality of data of a user, wherein the data comprises at least words and phrases from at least one of emails, messages, documents, and electronic communications, and receive a second data, the second data comprising anonymous frequency word counts of a plurality of users. The processor is further caused to determine a correspondence between the analyzed plurality of data and the second data, wherein the correspondence includes words and phrases that are interesting; and provide a list of words and phrases to the user based on the determined correspondence, wherein the list is selectable by the user.

A fourth exemplary embodiment of the present disclosure provides a method. The method includes analyzing, by a processor, a plurality of data from a plurality of users, the plurality of data comprising at least words and phrases from at least one of emails, messages, documents, and electronic communications, and determining, by the processor, a frequency for each of the words and phrases from the plurality of data. The method further includes creating, by the processor, at least one of a hash and encryption for each of the plurality of data, and transmitting, by the processor, the determined frequency to a plurality of user equipments.

A fifth exemplary embodiment of the present disclosure provides an apparatus. The apparatus includes at least one processor and at least one memory storing computer program instructions executable by the at least one processor, wherein the at least one memory with the computer program instructions and the at least one processor are configured to cause the apparatus to at least analyze a plurality of data from a plurality of users, the plurality of data comprising at least words and phrases from at least one of emails, messages, documents, and electronic communications, and determine a frequency for each of the words and phrases from the plurality of data. The at least one memory with the computer program instructions and the at least one processor are configured to cause the apparatus to further create at least one of a hash and encryption for each of the plurality of data, and transmit the determined frequency to a plurality of user equipments.

A sixth exemplary embodiment of the present disclosure presents a non-transitory computer-readable medium. The non-transitory computer-readable medium tangibly storing computer program instructions which when executed by a processor, cause the processor to at least analyze a plurality of data from a plurality of users, the plurality of data comprising at least words and phrases from at least one of emails, messages, documents, and electronic communications, and determine a frequency for each of the words and phrases from the plurality of data. The non-transitory computer-readable medium tangibly storing computer program instructions further cause to the processor to create at least one of a hash and encryption for each of the plurality of data, and transmit the determined frequency to a plurality of user equipments.

A seventh exemplary embodiment of the present disclosure presents a method. The method includes receiving, by a processor, a description from a source, and analyzing, by the processor, a plurality of data of a plurality of users, wherein the plurality of data comprises at least words and phrases from at least one of emails, documents, messages, and electronic communications of the plurality of users. The method further includes determining, by the processor, a correspondence between the analyzed plurality of data and the description, and transmitting, by the processor, a second data to at least one of the plurality of users that is associated with the plurality of data determined as having the correspondence.

An eighth exemplary embodiment of the present disclosure presents an apparatus. The apparatus includes at least one processor and at least one memory storing computer program instructions executable by the at least one processor, wherein the at least one memory with the computer program instructions and the at least one processor are configured to cause the apparatus to at least receive a description from a source, and analyze a plurality of data of a plurality of users, wherein the plurality of data comprises at least words and phrases from at least one of emails, documents, messages, and electronic communications of the plurality of users. The at least one memory with the computer program instructions and the at least one processor are configured to cause the apparatus to determine a correspondence between the analyzed plurality of data and the description, and transmit a second data to at least one of the plurality of users that is associated with the plurality of data determined as having the correspondence.

A ninth exemplary embodiment of the present disclosure presents a non-transitory computer-readable medium. The non-transitory computer-readable medium tangibly storing computer program instructions which when executed by a processor, cause the processor to at least receive a description from a source, analyze a plurality of data of a plurality of users, wherein the plurality of data comprises at least words and phrases from at least one of emails, documents, messages, and electronic communications of the plurality of users, determine a correspondence between the analyzed plurality of data and the description, and transmit a second data to at least one of the plurality of users that is associated with the plurality of data determined as having the correspondence.

A tenth exemplary embodiment of the present disclosure presents a method. The method comprises receiving, by a processor, a description from a source, and analyzing, by the processor, a plurality of data of a plurality of users, wherein the plurality of data comprises at least words and phrases from at least one of emails, documents, messages, and electronic communications of the plurality of users. The method further includes determining, by the processor, whether there is (i) a correspondence between the analyzed plurality of data and the description or (ii) that there is no correspondence between the analyzed plurality of data and the description, and transmitting, by the processor, a second data to the plurality of user's user equipments, wherein in the second data is a request for a connection and the description. The method still further includes determining, by the plurality of user's user equipments, a correspondence between the description and a plurality of connections, wherein the plurality of connections are maintained by the plurality of user's user equipments, and providing an option to share a subset of the plurality of connection that have a correspondence above a predetermined threshold with the source.

The following will describe embodiments of the present disclosure, but it should be appreciated that the present disclosure is not limited to the described embodiments and various modifications of the invention are possible without departing from the basic principles. The scope of the present disclosure is therefore to be determined solely by the appended claims.

### BRIEF DESCRIPTION OF THE SEVERAL VIEWS OF THE DRAWING(S)

FIG. 1 presents an exemplary device suitable for performing exemplary embodiments of the present disclosure.

FIG. 2 presents an exemplary signaling diagram suitable for performing exemplary embodiments of the present disclosure.

FIG. 3 presents block diagram of an exemplary device suitable for performing exemplary embodiments of the present disclosure.

FIG. 4 presents an exemplary device suitable for performing exemplary embodiments of the present disclosure.

FIG. 5 presents an exemplary signaling diagram suitable for performing exemplary embodiments of the present disclosure.

FIG. 6 presents an exemplary logic flow diagram in accordance with a method, apparatus, and computer-readable medium for performing exemplary embodiments of the present disclosure.

FIG. 7 presents another exemplary logic flow diagram in accordance with a method, apparatus, and computer-readable medium for performing exemplary embodiments of the present disclosure.

FIG. 8 presents yet another exemplary logic flow diagram in accordance with a method, apparatus, and computer-readable medium for performing exemplary embodiments of the present disclosure.

FIG. 9 presents an alternative exemplary logic flow diagram in accordance with a method, apparatus, and computer-readable medium for performing exemplary embodiments of the present disclosure.

FIG. 10 presents a block diagram of devices suitable for performing exemplary embodiments of the present disclosure.

### DETAILED DESCRIPTION OF THE INVENTION

Embodiments of the present disclosure provide a method, apparatus, and computer-readable medium to determine whether a colleague has knowledge in a particular area of interest without inadvertently disclosing sensitive material of that particular colleague.

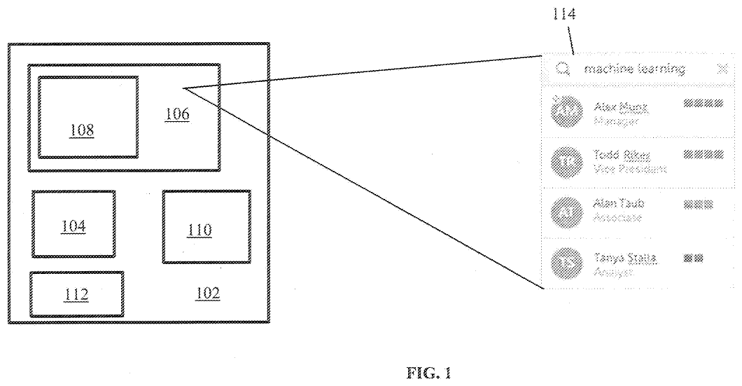

Referring to FIG. 1, shown is an exemplary diagram suitable for performing exemplary embodiments of the present disclosure. Illustrated in FIG. 1 is user equipment (UE) 102 operable by a user for bidirectional communication with other electronic devices. UE 102 is operable to send and receive data with other electronic devices. UE 102 includes a processor 104, a memory 106 with computer program instructions 108, a user interface 110 and a transmitter/receiver 112. Embodiments of processor 104 include any general-purpose computer processors, microprocessors, digital signal processors and multi-core processors. Embodiments of memory 106 include any type of memory known in the art including, without limitation, any data storage technology type which is suitable to the local technical environment. Embodiments of memory 106 include semiconductor-based memory devices, magnetic memory devices and systems, optical memory devices and systems, fixed memory, removeable memory, disc memory, flash memory, read only memory (ROM), random access memory (RAM), programmable read-only memory (PROM), erasable programmable read only memory (EPROM), dynamic random-access memory (DRAM), static random-access memory (SRAM), electrically erasable programmable read-only memory (EEPROM) and the like. Embodiments of computer program instructions 108 include any type of program, application, cloud application, computer instructions or program instructions that, when executed by processor 104, enable UE 102 to operate in accordance with embodiments of the present disclosure as detailed herein. Embodiments of user interface 110 are operable to allow a user to operate UE 102 as described herein. Embodiments of user interface 110 can include a display, a touch screen, a keypad, a keyboard, and/or speakers/microphones. Embodiments of UE 102 are operable to send and receive data through wired or wireless communication with other devices (e.g., servers, internet, computers, smart phones, cloud servers, etc.) via transmitter/receiver 112. Embodiments of UE 102 include desktop computers, servers, cloud servers, laptop computers, tablets, smartphones, smart watches, wearable devices, and the like. It should be appreciated for the embodiment that UE 102 is a server or cloud server, UE 102 will not include a user interface 110, but will be accessible by a user through another UE (e.g., computer, laptop, table, smartphone, wearable device, etc.) having a user interface that can access and communicate with UE 102. It should also be appreciated that will FIG. 1 only depicts a single UE 102, embodiments include UE 102 being a plurality of UEs (e.g., a plurality of servers, a plurality of computers, etc.).

In practice, UE 102 operates within a large, midsize or small organization or company the employs many employees or has many individuals. The user of UE 102 wants to find a particular person or lists of particular persons who have a particular skill set or expertise (e.g., expertise in artificial intelligence, blockchain, oncology, intellectual property, accounting, psychology, physics, etc.). However, neither the user of UE 102 nor UE 102 knows who within the organization or company has the particular skill set or expertise. Additionally, the organization or company may not have a complete list of all the skill sets or expertise of its employees. For example, the user of UE 102 may need to find an in-house expert on a particular topic (e.g., machine learning, artificial intelligence, quantum mechanics, lasers, mechanical engineering, software development, electrical engineering, contract negotiation, mergers, litigation, etc.). Embodiments of the present disclosure will identify a user's collaborators (i.e., the individuals, companies, organizations with whom he/she works with, associated with, or is connected to in a social network including private networks and/or online social networks) that match the skill set or expertise he/she desires. The list of collaborators that match the desired expertise (e.g., in machine learning) are identified in list 114. In another example, a user may want to find experts from among his/her social relationships (e.g., relationships from social networks).

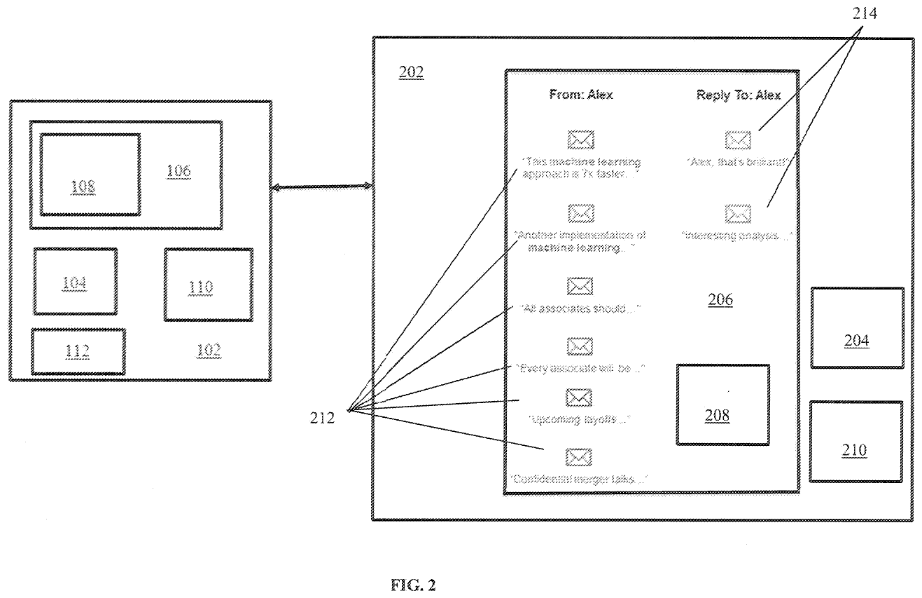

Since the skill set or expertise, or the full range of expertise of a given individual within an organization or company may not be known, embodiments provide a process for determining an individual's expertise. Referring to FIG. 2, shown is a portion of the process for determining an individual expertise. As shown in FIG. 2, embodiments provide that UE 102, a plurality of UEs, or server 202 can analyze (through natural language processing (NLP)) of the number, frequency, and quality of words and phrases contained in the emails, text messages, messages, documents, text, browsing histories, and/or social media posts of an individual can aid in determining an individual's expertise. Embodiments of server 202 include one or multiple servers 202 that include at least one processor 204, at least one memory 206, at least one computer program 208, and a transmitter/receiver 210 for communicating and transmitting data with other UEs and servers including UE 102. For instance, in FIG. 2, UE 102, a plurality of UEs, server 202 or a plurality of servers are operable to perform an NLP analysis of one user's (Alex's) messages and documents to determine whether Alex has a high incidence rate of, for example, the phrase “machine learning” in his messages and documents 212. Embodiments include messages and documents 212 being maintained in a central location (e.g., server 202) or in multiple locations (e.g., a plurality of servers 202). Additionally, reply emails 214 to Alex contain positive language when discussing “machine learning.” In this example, the analysis could identify Alex as a likely expert in “machine learning.”

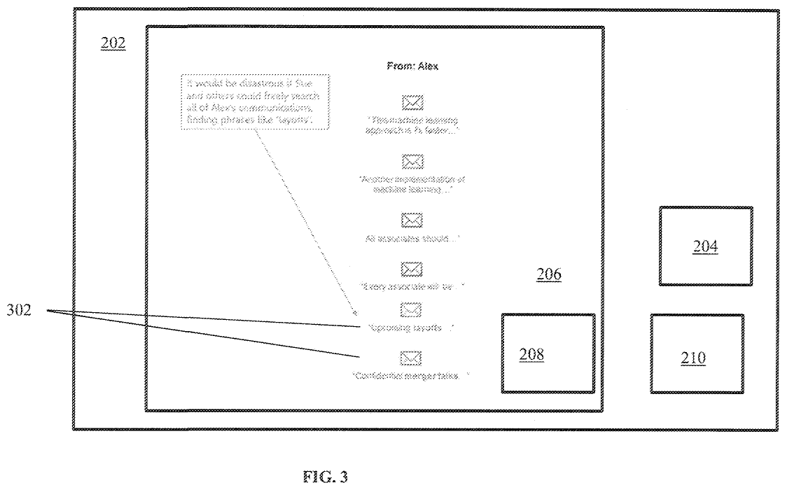

However, a pure NLP analysis of an individual's emails, text messages, messages, documents, and/or social media posts may include words, phrases or topics that an individual might not want shared with other individuals. For instance, as shown in FIG. 3, the bottom two emails 302 include a discussion of “Upcoming layoffs . . . ” and “Confidential merger talks . . .” Accordingly, there is a need to keep sensitive data, information and/or materials from being shared from one individual to another.

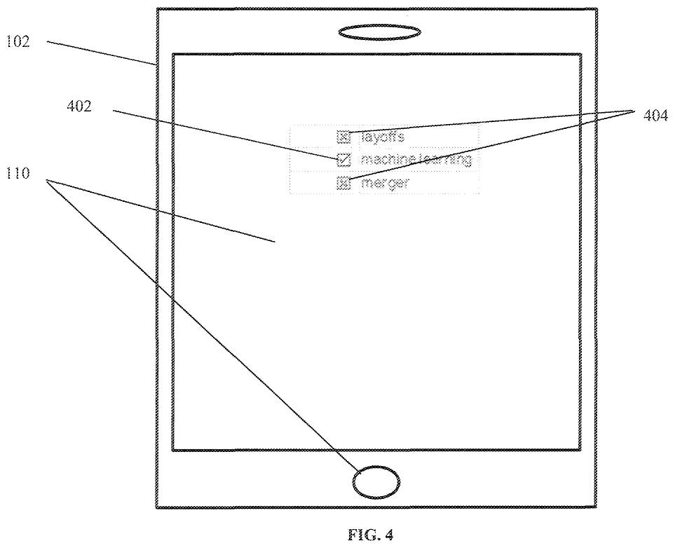

One option to protect the privacy of an individual is shown in FIG. 4. Shown in FIG. 4 is UE 102 having user interface 110, which includes a circular button and a touch screen. It should be appreciated that while UE 102 is depicted as a smartphone or tablet, embodiments include any other electronic device operable to perform the functions described herein. Shown in user interface 110 is a displayed opportunity for a user to manually redact (i.e., not share) topics, words, and/or phrases from the list of topics, words, and/or phrases that are found during the NLP analysis. As shown in FIG. 4, the user has decided to share “machine learning” (as indicated by the checkmark 402), but has redacted (i.e., not shared) “merger” and “layoffs” (as indicated by the X's 404).

Another difficulty with an NLP analysis is that the topics, words, and/or phrases determined during the analysis need to be of relevance to other individuals that the topics, words, and/or phrases will find relevant. For example, a user's list of keywords to review for sharing must be manageable (i.e., there cannot be too many words/phrases to redact) and must be those words and/or phrases that his collaborators or colleagues would find relevant. The frequency of particular words and/or phrases will vary depending on the company or organization. For example, everyone at a particular user's company may use the terms “account executive,” “action,” “activity,” “assistant,” and “associate” a lot more than typically used by the general public. As such, the fact that a particular user uses these terms will not be relevant to review or share.

Accordingly, embodiments of the present disclosure provide that the analysis of an individual's or user's words and/or phrases within the individual's or user's emails, messages, social media posts, online publications, and/or documents will be compared to the occurrence or usage of those same words and/or phrases by that individual's or user's collaborators. A user's word and/or phrase usage will be assessed relative to that of his collaborators to filter out the words and/or phrases that are indicative of the user's skills or expertise from the words and/or phrases that are simply common among the user's collaborators even though those words and/or phrases may not be generally used as often by the general public. In other words, embodiments include (i) determining the occurrence of particular words and/or phrases used by a user in the user's emails, messages, social media posts, online publications, and/or documents, (ii) determining the occurrence of particular words and/or phrases used by the user's collaborators in the collaborator's emails, messages, social media posts, online publications, and/or documents, (iii) optionally or automatically providing the option for the user to remove certain words and/or phrases for privacy and confidentiality considerations, and (iv) comparing the two determinations to determine the relevancy of particular words and/or phrases of the user relative to the collaborators. In this regard, the relevancy of a particular word and/or phrase of an individual or user can be determined to be relatively relevant to an individual's collaborators.

However, in order to determine the relative relevancy of a particular individual's word and/or phrase counts, a system would need access to an individual's collaborator's word and/or phrase counts. Yet, in order to protect the privacy of an individual's word and/or phrase counts, embodiments of the present disclosure provide that a central database and/or server will not have or require access to both (i) each individual's word and/or phrase counts on the user's emails, messages, and/or documents, and (ii) the identity of the user associated with each word and/or phrase counts from the emails, messages, and/or documents. It should be appreciated that embodiments include a central database and/or server that has access to each individual's emails, messages, and/or documents having words and/or phrases, but not the identity of the individual associated with each word and/or phrase. In yet another embodiment, a central database and/or server may have access to both each individual's word and/or phrase counts, and the identity of the individual associated with each word and/or phrase count. In this embodiment, though the central database and/or server may have access to the data and identity information, access by individuals or users within the organization or company can be limited through manual redaction disclosed herein and through limited access permissions to the data maintained by the central database and/or server.

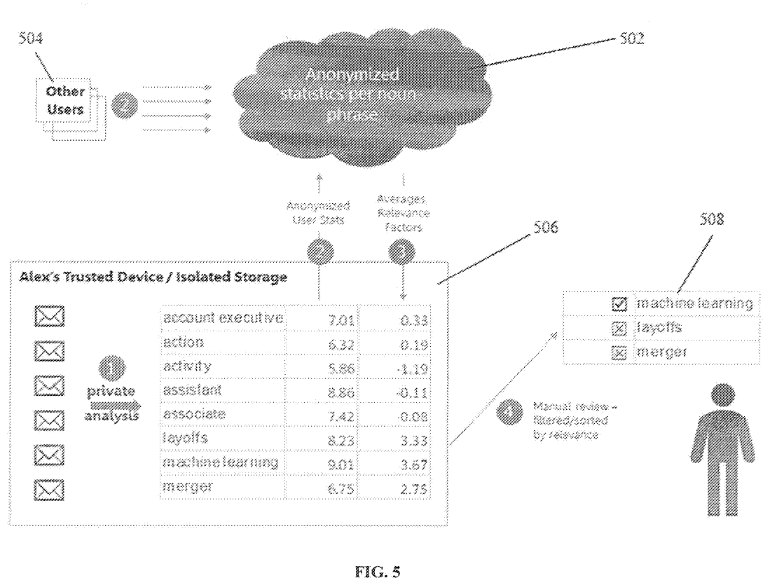

Embodiments of the present disclosure are accomplished by the process or method illustrated in FIG. 5. Shown in FIG. 5, each individual (or user) will provide their word and/or phrase counts without having the identity of the user being associated with the word and/or phrase counts. In this regard, the word and/or phrase counts for each user will be anonymous. Each individual's word and/or phrase counts will be combined in the aggregate, but no particular individual's word and/or phrase counts will be available or accessible. The anonymous statistics of words and/or phrases is shown at server 502. In this step, a plurality of users 504 will provide their word and/or phrases from emails, messages, documents, and/or electronic communications in an anonymous form such that their source cannot be determined. Then each individual user equipment (UE) 506 (e.g., desktop, laptop, smart phone, tablet, wearable, trusted computing environment, virtual private network, trusted cloud resource, etc.) will maintain a specific individual's words and/or phrases. The individual's UE 506 will receive the anonymous word and/or phrase counts of his/her collaborators 504 from server 502. The UE 56 will analyze the user's word and/or phrase counts within emails, messages, etc. in comparison to the average word and/or phrase counts from server 502 to determine a list 508 of words and/or phrases that are relevant to the user's collaborators. The list can be provided to the user to then manually redact the words and/or phrases that the user desires to not share. In one embodiment the list 508 is not provided to the user, but the list of words and/or phrases is automatically redacted based on predetermined instructions or rules. For instance, the list 508 may be automatically redacted based on a second list of words and/or phrases that are predetermined to be excluded or redacted from the list 508. In another embodiment, the list 508 is automatically redacted based on a rule set that redacts words and/or phrases that are determined to belong within a predetermined category. For instance, an embodiment of a predetermined category might include legal advice, or medical information. UE 506 will automatically redact words and/or phrases of the user that are related to those predetermined categories.

The user's words and/or phrases are then allowed to be shared with other collaborators within a company or organization. The words and/or phrases will be used to determine whether a particular individual is an expert in a particular area.

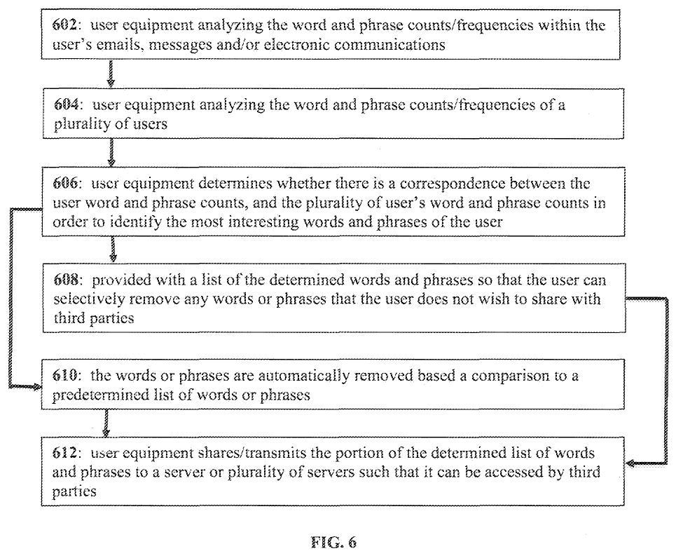

In practice, the process is shown in FIG. 6, which illustrates a simplified logic flow diagram. The process begins with block 602, which states that a user equipment analyzing the word and phrase counts/frequencies within the user's emails, messages and/or electronic communications. However, these word counts are not that useful unless they are put in the context of usage by the user's peers/colleagues. As such, next at block 604, the process includes the user equipment analyzing the word and phrase counts/frequencies of a plurality of users. The word and phrase counts/frequencies of the plurality of users are anonymized, hashed and/or encrypted to protect the identities of the users associated with this data. Next at block 606, the user equipment determines whether there is a correspondence between the user word and phrase counts, and the plurality of user's word and phrase counts in order to identify the most interesting words and phrases of the user. Interesting in this context refers to words and phrase counts of the user that are statistically higher than that found by the plurality of user data. Then at block 608, the user is provided with a list of the determined words and phrases so that the user can selectively remove any words or phrases that the user does not wish to share with third parties. In an alternative embodiment, at block 610 the words or phrases are automatically removed based a comparison to a predetermined list of words or phrases. Finally, at block 612, the user equipment shares/transmits the portion of the determined list of words and phrases to a server or plurality of servers such that it can be accessed by third parties.

Embodiments also include analyzing a plurality of data from a plurality of users by a central server, computer or other electronic device. The plurality of data includes emails, messages, and/or electronic communications. Next, frequency word and phrase counts are determined for the plurality of data by a central server, computer or other electronic device. Finally, the frequency word and phrase counts for the plurality of data is hashed and/or encrypted such that it cannot be determined which particular user is associated with which particular analyzed data by a central server, computer or other electronic device. The hashed and/or encrypted data is then available for transmission to user's user equipments who want to perform elements of the process described above.

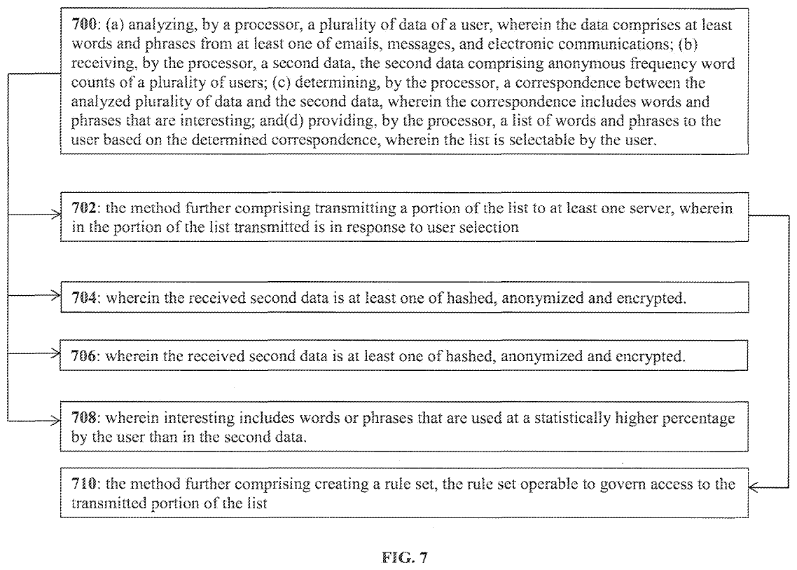

Referring to FIG. 7, presented is a logic flow diagram in accordance with a method, apparatus, and computer-readable medium for performing exemplary embodiments of this disclosure. Block 700 presents (a) analyzing, by a processor, a plurality of data of a user, wherein the data comprises at least words and phrases from at least one of emails, messages, and electronic communications; (b) receiving, by the processor, a second data, the second data comprising anonymous frequency word counts of a plurality of users; (c) determining, by the processor, a correspondence between the analyzed plurality of data and the second data, wherein the correspondence includes words and phrases that are interesting; and(d) providing, by the processor, a list of words and phrases to the user based on the determined correspondence, wherein the list is selectable by the user. Then block 702 states the method further comprising transmitting a portion of the list to at least one server, wherein in the portion of the list transmitted is in response to user selection.

Following block 702, block 704 relates to wherein the received second data is at least one of hashed, anonymized and encrypted. Block 706 then specifies wherein the received second data is at least one of hashed, anonymized and encrypted. Block 708 states wherein interesting includes words or phrases that are used at a statistically higher percentage by the user than in the second data. Finally, block 710 states the method further comprising creating a rule set, the rule set operable to govern access to the transmitted portion of the list.

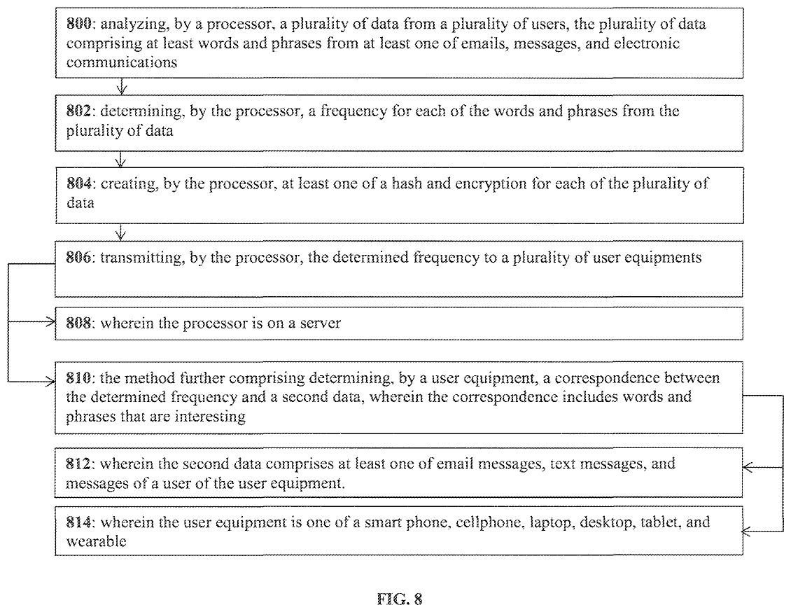

Referring to FIG. 8, presented is yet another logic flow diagram in accordance with a method, apparatus, and computer-readable medium for performing exemplary embodiments of this disclosure. Block 800 states analyzing, by a processor, a plurality of data from a plurality of users, the plurality of data comprising at least words and phrases from at least one of emails, messages, and electronic communications. Block 802 then relates to determining, by the processor, a frequency for each of the words and phrases from the plurality of data. Block 804 states creating, by the processor, at least one of a hash and encryption for each of the plurality of data. Next block 806 relates to transmitting, by the processor, the determined frequency to a plurality of user equipments.

Following block 806, block 808 specifies wherein the processor is on a server. Block 810 states the method further comprising determining, by a user equipment, a correspondence between the determined frequency and a second data, wherein the correspondence includes words and phrases that are interesting. Next, block 812 relates to wherein the second data comprises at least one of email messages, text messages, and messages of a user of the user equipment. Finally, block 814 states wherein the user equipment is one of a smart phone, cellphone, laptop, desktop, tablet, and wearable.

The logic flow diagram of FIG. 7 and FIG. 8 may be considered to illustrate the operation of a method, a result of execution of computer program instructions stored in a computer-readable medium. The logic diagram of FIG. 7 and FIG. 8 may also be considered a specific manner in which components of the device are configured to cause that device to operate, whether such a device is an electronic device, laptop, tablet, desktop, mobile phone, smartphone, or other device, or one or more components thereof. The various blocks shown in FIG. 7 and FIG. 8 may also be considered as a plurality of coupled logic circuit elements constructed to carry out the associated function(s), or specific result of strings of computer program instructions or code stored in memory.

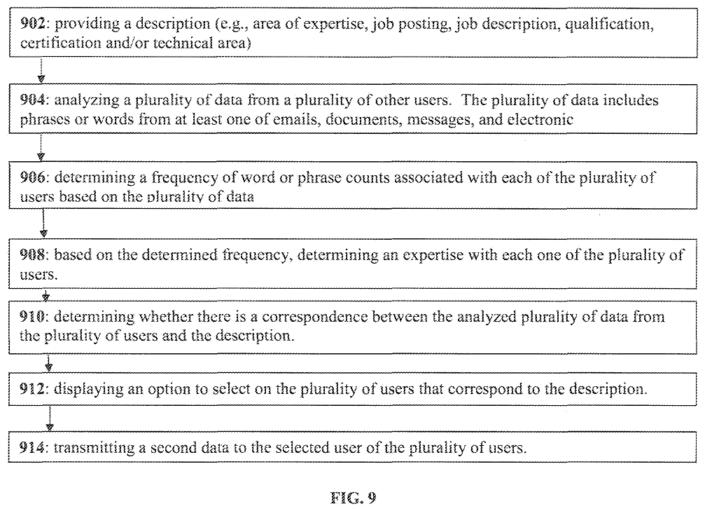

Referring to FIG. 9, shown is an exemplary process in accordance with embodiments of the present disclosure. In this embodiment, a user is able to efficiently locate other users who they know (e.g., work colleagues, friends, and social network colleagues) that fit or meet a particular description (e.g., skills, knowledge, or expertise in a particular area) so that the user can collaborate, communicate, and/or engage with the user that fits or meets the description. This embodiment further provides a process for determining whether a user's description corresponds to the expertise of another user so that the user can begin to communicate with the other user.

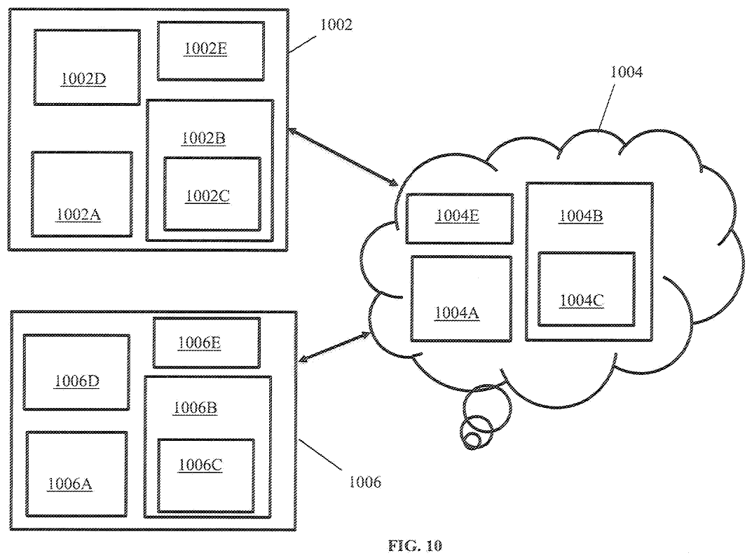

This embodiment begins at block 902, which allows a user (also referred to as a source) through a UE to provide a description. The description can be an area of expertise, a job posting, a job description, a qualification, a certification, and/or a technical area. Next at block 904, the system (which can include one or more servers, user equipments, computers, and/or processors shown in FIG. 10) analyzes a plurality of data from a plurality of other users. The plurality of data includes phrases or words from at least one of emails, documents, messages, and electronic communications of the plurality of users. It should be appreciated that the plurality of data of the plurality of users can be anonymized such that no one user of the plurality of users can be associated with a particular word or phrase. In other words, the plurality of data cannot be associated or connected to which one of the plurality of users it is in fact from. The source of the plurality of data is therefore anonymous. In another embodiment, the plurality of data is not anonymized. The plurality of users is based on the contacts, social network connections, telephone calls, text messages, calendar appointments, emails, and company personnel lists associated with the source. Next at block 906, the system, server or UE determines a frequency of word or phrase counts associated with each one of the plurality of users based on the plurality of data. Next at block 908, based on the frequency of word or phrase counts associated with the data of a particular user, an expertise, a qualification, a certification, a technical area, a job, or a title can be associated with each particular user. It should be appreciated that embodiments of the plurality of data include information and data that is publicly available (e.g., online profiles, LinkedIn information, articles, information available through Google, Facebook, etc.). It should also be appreciated that embodiments of the plurality of data include information and data that may not be publicly accessible, but is accessible through similar systems that are connected to the searching system. For instance, embodiments include users in company A (having its own network of computers, servers, messages, emails and user profiles) providing their data and users in company B (having its own network of computers, servers, messages, emails and user profiles) providing their data as well. While company A's data and company B's data are not comingled (e.g., in the same system, server, network, computer, database, etc.) and are not accessible by users of the other company, embodiments include a system wherein the data from each company is anonymized such that an individual user's data cannot be traced to a particular user and the data can be used as described herein to find a correspondence. Embodiments further include users from different company's receiving a request to be connected when a correspondence is discovered. It should be appreciated that embodiments allow individual users to redact particular words or phrases from being considered or corresponding to that individual user.

Next the system at block 910 determines whether there is a correspondence between the analyzed plurality of data from the plurality of users and the description from the source. The determining can include identifying the users that have the highest word or phrase counts related to the description provided by the source. It should be appreciated that the determining can include a ranking of the top 1, 5, 10, 20, 100, etc. users that correspond to the description. The source then can be presented (shown at block 912) with an option to select from the list of users that correspond to the description or the top users can be automatically selected for the source. Finally, the system at block 914 transmits a second data to the selected user or users. The second data can be an email message, a text message, or an introduction request from the source to the selected user. It should be appreciated that embodiments of this process provide for the instance that the source knows all the plurality of users and for the instance that the source does not already know all the plurality of users. For example, there may be instances in which the source is employed by a company or organization that is so vast that the source simply does not know all of the employees within the company or organization. In this case, the system may have access to the plurality of data of all the employees within the company or organization even though the source does not specifically know all the employees. In another embodiment, the system may not find any users that meet or match the description above a certain threshold or that are poor matches for the description. In this embodiment, the user of the UE or the server is operable to transmit a request asking for users that meet or match the description. In one embodiment, the server that maintains the plurality of data from the plurality of users may have data related to users that were not included in the plurality of data previously analyzed. In this embodiment, the server or system is operable to determine whether the data of those users who were not previously analyzed have a correspondence (relative to other users) to the description. If the server or system determines that there is a correspondence then the server will be operable to transmit a request to the users that have a correspondence with a request to connect to the user who authored the description. In another embodiment, if a user having a correspondence to the description is not found or a correspondence below a certain threshold is not found then the user through the UE may transmit a request to the server indicating that the user is still looking for a match to the description. In this embodiment the server does not know the identity of the user's associated with the plurality of data. In this embodiment the server will maintain the request from the user and other user's UEs whose data was not previously analyzed can pull down the description. The users who pull down the request will determine whether there is a correspondence between the user's data and/or expertise and the description. If there is a correspondence, the user will receive a prompt or notification on their UE to connect with the user who authored the description.

For example, User 1 might be searching for individuals who have expertise, skills or engagement on the topic of “chatbots” within company ABC Co. User 1 discovers that there are colleagues who have expertise, skills or engagement with “chatbots” and decides to reach out to another user (User 2). In this embodiment, User 1 inputs in a search engine “chatbots in the enterprise”. In this example, User 1 is looking for individuals having expertise in chatbots that are within the company or organization. After analyzing the data of the other users within the enterprise (e.g., company, network or organization), the system may identify that User 2, User 3, and User 4 as possible colleagues within the enterprise who have expertise in the area of chatbots. In this example, the system can also rank User 2, User 3, and User 4 in order of who has the most expertise. This ranking can be based on the frequency of particular words and/or phrases within a user's data relative to the frequency of other users.

An exemplary second data the second data includes an email message. For instance, a second data can be an email to User 2 introducing User 1 and identifying that User 1 desires to engage in a conversation with User 2. Referring to FIG. 10, shown is an exemplary block diagram illustrating embodiments of devices suitable for use in practicing exemplary embodiments of the present disclosure. Shown in FIG. 10 is UE 1002, server 1004, and a plurality of UEs 1006. UE 1002 is a smart phone, computer, laptop, tablet, wearable device or other electronic device operable for bidirectional communication with server 1004 and a plurality of UEs 1006. UE 1002 includes at least one processor 1002A, at least one memory 1002B storing at least one computer program 1002C, a user interface 1002D and a receiver/transmitter 1002E. Server 1004 includes one or multiple servers and can be operable in a public or private network. Server 1006 includes at least one processor 1004A, at least one memory 1004B storing at least one computer program 1004C, and a receiver/transmitter 1004E. Embodiments of server 1004 is operable for bidirectional wired or wireless communication with UE 1002 and plurality of UEs 1006. Plurality of UEs 1006 are similar to UE 1002 and each includes at least one processor 1006A, at least one memory 1006B storing at least one computer program 1006C, a user interface 1006D and a receiver/transmitter 1006E. Embodiments provide that server 1004 is operable to receive a plurality of data from UEs 1006, which can include a plurality of words and/or phrases. Server 1004 is operable to maintain the data received from UEs 1006. In one embodiment, upon receipt of instructions from UE 1002, server 1006 is operable to perform the steps detailed in FIG. 9 such that a user of UE 1002 is able to receive a list of users have expertise in a specified area and then is able to reach out to a particular user through a message, email or other type of communication. In another embodiment, UE 1002 performs the steps of FIG. 9 such that UE 1002 is able to receive a list of users have expertise in a specified area and then is able to reach out to a particular user through a message, email or other type of communication.

In another exemplary embodiment of the present disclosure, the user of UE 1002 is again searching for another user that has expertise in a particular area. In this embodiment, UE 1002 or server 1004 is unable to find a user who has declared engagement, skills or expertise, allowed their data to be searched, or is connected to the user. In other words, none of the users of UEs 1006 match the description, skills or expertise specified by UE 1002 or server 1004. It should be appreciated that embodiments include instances in which UE 1002 or server 1004 are able to find a UE 1006 who has declared engagement, allowed their data to be search, or is connected to the user. In yet another aspect, embodiments include instances in which UE 1002 or server 1004 is able to find a UE 1006 who has declared engagement, allowed their data to be search, or is connected to the user, but the user associated with UE 1006 is not ideal or only partially matches or meets the expertise in the particular area. As such, this embodiment allows a UE 1002 or server 1004 to send out the description, which allows other UEs 1006 (e.g., the system itself or the user equipment of the user) to determine whether the description has a correspondence to a data or a plurality of data (e.g., data of users having UEs that are not UE 1002 or UEs 1006), and then provides the correspondence (if it exists) to the unknown user or owner of the data along with an option to connect with the source of the description. The data or plurality of data in this case are the connections, words, phrases of the user receiving the description. In other words, embodiments allow a user of UE 1002 to leverage the connections of the user's connections (i.e., the connections, collaborators of UEs 1006. Embodiments provide a method, apparatus, and computer-readable medium for a user's connections to determine whether that user's connections (people or companies with whom the user has a relationship based on data derived from e.g., telephone contacts, Facebook friends, Linkedln connections, calendar meetings/lunches, emails, text messages, telephone calls) meet the criteria of a description (e.g., job posting, job description, introduction request, qualification, field of expertise, certification, etc.).

For example, the user of UE 1002 1 might be searching for individuals having expertise in “affordability solutions for oncology”. In this instance, no individuals are found by UE 1002 or server 1004 in UEs 1006. It should be appreciated that embodiments include the instance in which individuals or UEs 1006 are found as having a correspondence. In other words, the user of UE 1002 does or does not have a connection (i.e., within the plurality of users) that have an expertise (based on analyzing the plurality of data of the plurality of user) in this area. Then UE 1002 is provided with an option to send a request to other individuals (for example up to 3 people or UEs) to see whether those other individuals have connections that have expertise in this area. Each of the UEs 1006 that receive the request may optionally search or determine whether their connections (i.e., UEs that allow access to the words and/or phrases included in emails, messages, and/or documents) have a correspondence to the expertise. UEs 1006 will then optionally send a request (e.g., email, message or other electronic message) to the user's UE that has a correspondence to the expertise asking whether that user wants to be introduced to the user of UE 1002. Finally, the UE that has a correspondence will be introduced (e.g., via an email, message or other electronic message) to the user of UE 1002.

This disclosure has been described in detail with particular reference to a presently preferred embodiment, but it will be understood that variations and modifications can be affected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

1. A method comprising:
(a) receiving, by a processor, a description from a source;
(b) analyzing, by the processor, a plurality of data of a plurality of users, wherein the plurality of data comprises at least words and phrases from at least one of emails, documents, messages, and electronic communications of the plurality of users;
(c) determining, by the processor, a correspondence between the analyzed plurality of data and the description; and
(d) transmitting, by the processor, a second data to at least one of the plurality of users that is associated with the plurality of data determined as having the correspondence.

2. The method according to claim 1, wherein the description is at least one of an area of expertise, a job posting, a job description, a qualification, a certification, and technical area.

3. The method according to claim 1, wherein the plurality of users is based on at least one of a list of contacts, social network connections, telephone calls, text messages, calendar appointments, emails, and company personnel lists.

4. The method according to claim 1, wherein the second data comprises at least one of an email message, a text message, and an introduction request from the source of the description to the at least one of the plurality of users having the determined correspondence.

5. The method according to claim 1, wherein the at least one of the plurality of users is known to the source.

6. The method according to claim 1, wherein the at least one of the plurality of users is unknown to the source.

7. The method according to claim 1, wherein the plurality of data is inaccessible by the source.

8. An apparatus comprising at least one processor and at least one memory storing computer program instructions executable by the at least one processor, wherein the at least one memory with the computer program instructions and the at least one processor are configured to cause the apparatus to at least:
(a) receive a description from a source;
(b) analyze a plurality of data of a plurality of users, wherein the plurality of data comprises at least words and phrases from at least one of emails, documents, messages, and electronic communications of the plurality of users;
(c) determine a correspondence between the analyzed plurality of data and the description; and
(d) transmit a second data to at least one of the plurality of users that is associated with the plurality of data determined as having the correspondence.

9. The apparatus according to claim 8, wherein the description is at least one of an area of expertise, a job posting, a job description, a qualification, a certification, and technical area.

10. The apparatus according to claim 8, wherein the plurality of users is based on at least one of a list of contacts, social network connections, telephone calls, text messages, calendar appointments, emails, and company personnel lists.

11. The apparatus according to claim 8, wherein the second data comprises at least one of an email message, a text message, and an introduction request from the source of the description to the at least one of the plurality of users having the determined correspondence.

12. The apparatus according to claim 8, wherein the at least one of the plurality of users is known to the source.

13. The apparatus according to claim 8, wherein the at least one of the plurality of users is unknown to the source.

14. The apparatus according to claim 8, wherein the plurality of data is inaccessible by the source.

15. A non-transitory computer-readable medium tangibly storing computer program instructions which when executed by a processor, cause the processor to at least:
(a) receive a description from a source;
(b) analyze a plurality of data of a plurality of users, wherein the plurality of data comprises at least words and phrases from at least one of emails, documents, messages, and electronic communications of the plurality of users;
(c) determine a correspondence between the analyzed plurality of data and the description; and
(d) transmit a second data to at least one of the plurality of users that is associated with the plurality of data determined as having the correspondence.

16. The non-transitory computer-readable medium according to claim 15, wherein the description is at least one of an area of expertise, a job posting, a job description, a qualification, a certification, and technical area.

17. The non-transitory computer-readable medium according to claim 15, wherein the plurality of users is based on at least one of a list of contacts, social network connections, telephone calls, text messages, calendar appointments, emails, and company personnel lists.

18. The non-transitory computer-readable medium according to claim 15, wherein the second data comprises at least one of an email message, a text message, and an introduction request from the source of the description to the at least one of the plurality of users having the determined correspondence.

19. The non-transitory computer-readable medium according to claim 15, herein the at least one of the plurality of users is one of known and unknown to the source.

20. The non-transitory computer-readable medium according to claim 15, wherein the plurality of data is inaccessible by the source.

21. A method comprising:
(a) receiving, by a processor, a description from a source;
(b) analyzing, by the processor, a plurality of data of a plurality of users, wherein the plurality of data comprises at least words and phrases from at least one of emails, documents, messages, and electronic communications of the plurality of users;
(c) determining, by the processor, whether there is (i) a correspondence between the analyzed plurality of data and the description or (ii) that there is no correspondence between the analyzed plurality of data and the description; and
(d) transmitting, by the processor, a second data to the plurality of user's user equipments, wherein in the second data is a request for a connection and the description;
(e) determining, by the plurality of user's user equipments, a correspondence between the description and a plurality of connections, wherein the plurality of connections are maintained by the plurality of user's user equipments;
(f) providing an option to share a subset of the plurality of connection that have a correspondence above a predetermined threshold with the source.

22. The method according to claim 21, wherein the plurality of connections is based on at least one of a list of contacts, social network connections, telephone calls, text messages, calendar appointments, and emails.

23. The method according to claim 21, wherein the determining includes ranking the plurality of connections based on at least one of a similarity to the description and the connectedness to the plurality of connections.

24. The method according to claim 21, wherein the connectedness is based on an importance, job seniority, and/or relationship-strength of the connection.
